(19) United States
(12) Patent Application Publication
(10) Pub. No.: US 2001/0011843 A1
(43) Pub. Date: Aug. 9, 2001

(54) Method and device for detecting wheel lockup in transport device

(76) Inventors: Ville Makilaine, Tampere (FI); Arto Siili, Hameenlinna (FI); Markku Makilaine, Seinajoki (FI)

Correspondence Address: YOUNG & THOMPSON, 745 SOUTH 23RD STREET 2ND FLOOR, ARLINGTON, VA, 22202

(21) Appl. No.: 09/778,721

(22) Filed: Feb. 8, 2001

(30) Foreign Application Priority Data
Feb. 9, 2000 (FI) 20000272

(51) Int. Cl. B60T 8/32; B60T 8/72

(52) U.S. Cl. 303/138; 188/1.11 E; 303/171

(57) ABSTRACT

A method and device for detecting the lockup of a transport device wheel. The rotating of the wheels is detected using sensors. Data about the rotating of the wheels is relayed to a control unit which monitors the rotating of the wheels for a predetermined control period. If the control unit detects, on the basis of the information received from the sensors, that at least one of the wheels is locked up, the control unit sends an alarm unit a command for raising an alarm. When the alarm unit receives the command, it raises an alarm to warn the driver that one or more wheels are locked up.

### BACKGROUND OF THE INVENTION

The invention relates to detecting lockups occurring in the wheels of transport devices, particularly in those of heavy-duty transport devices.

Different transport devices, for example trailers of heavy-duty transport equipment, are mostly provided with either drum brakes or disc brakes. In winter weather, freezing has been noticed to occur in the brakes of many transport devices, particularly in those of heavy-duty trailers: the gap between the brake drum and the brake plate is not tight and therefore snow gets between them. When the driver brakes, temperature in the drum rises considerably and after the braking there is water in the drum. When the vehicle is parked, the hand brake is usually activated, whereby the brake shoes rest against the ring of the drum. The water in the drum cools and in sub-zero temperatures it freezes. When the driver starts off again, one or more of the wheels is frozen and does not rotate. In heavy-duty transport devices in particular, the driver often does not notice the lockup. This easily leads to hazardous situations and tyre breakdown, which may cause considerable costs. The problem of freezing has also appeared in connection with disc brakes, and after braking when the transport device is still moving.

### BRIEF DESCRIPTION OF THE INVENTION

It is therefore an object of the invention to provide a method and equipment implementing the method to allow the above problems to be solved. The objects of the invention are achieved with a method and detector device characterized by what is stated in the independent claims. The preferred embodiments of the invention are disclosed in the dependent claims.

The underlying idea of the invention is to monitor the rotating of the wheels in the transport device and to raise an alarm to the driver if even one of the wheels is locked up. The rotating of the wheels is detected with sensor means which relay information about the rotating to a control unit. The control unit monitors the information coming from the sensor means for a predetermined time period and commands the alarm unit to raise an alarm if the information relayed from the sensor means indicates that at least one of the wheels is locked up. In response to the command received from the control unit, the alarm unit raises an alarm using a light and/or sound signal, for example. If the information relayed from the sensor means during the predetermined control period indicates that all the wheels are rotating, the control unit preferably starts to monitor again the information relayed from the sensors. According to a preferred embodiment of the invention, pulse data is relayed from the sensor means to the control means when the wheels are rotating. If there is at least one sensor means from which the control unit does not receive pulse data within the predetermined control period, the control unit commands the alarm unit to raise an alarm.

An advantage of the method and equipment of the invention is that the driver is rapidly warned of lockup of one or more wheels caused particularly by freezing or a damaged bearing. Also an indication of a worn bearing may be provided to the driver. This allows to avoid or at least to reduce hazardous situations and tyre breakdowns due to driving on a locked wheel. In addition, a deflated tyre which no longer rotates may be detected. An advantage of the preferred embodiment of the invention is its simplicity.

### BRIEF DESCRIPTION OF THE INVENTION

In the following the invention will be described in greater detail in connection with preferred embodiments and with reference to the accompanying drawings, in which

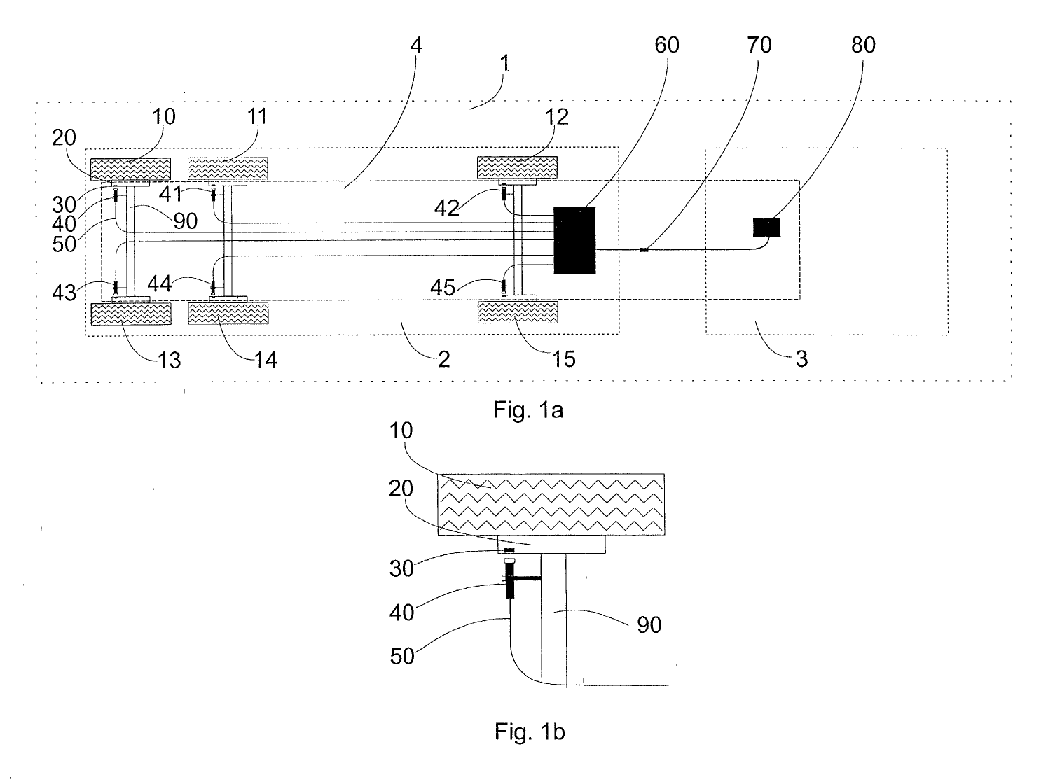

FIGS. 1a and 1b illustrate a transport device according to a preferred embodiment of the invention;

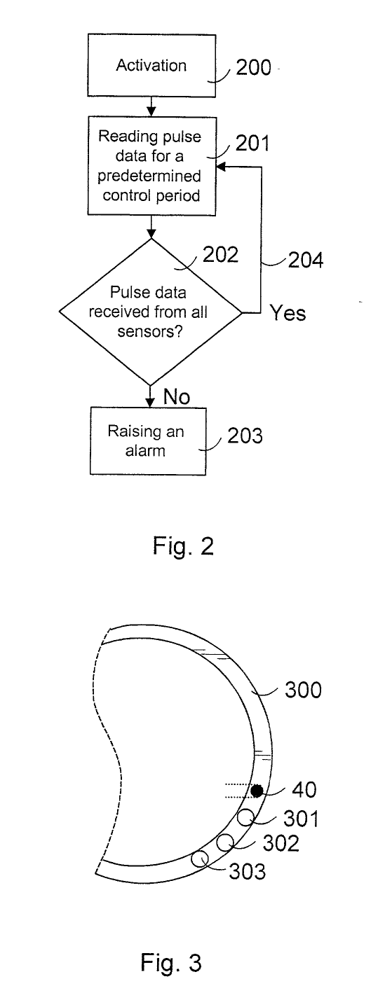

FIG. 2 is a flow diagram illustrating the operation of a control unit of a preferred embodiment of the invention; and

FIG. 3 illustrates a preferred embodiment of the invention implemented in connection with a disc brake provided with an ABS ring.

### DETAILED DESCRIPTION OF THE INVENTION

In the following, a preferred embodiment of the invention is described in which a detector device is used for detecting the lockup of trailer wheels. However, the invention may be applied to any transport device, a particular reference being here made to a heavy-duty transport vehicle having at least two wheels. The transport device may consist of for example a towing vehicle or a trailer, or a combination of a trailer and a towing vehicle.

FIG. 1a illustrates a transport device 1, taking into account only the parts that are relevant in the preferred embodiment of the invention, the transport device comprising a trailer 2 provided with drum brakes and a towing vehicle 3. The transport device 1 further comprises a detector device 4 employing inductive sensors 40, 41, 42, 43, 44 and 45 to measure the rotating of wheels 10, 11, 12, 13, 14 and 15 of the trailer. The trailers may be provided with single or dual wheels. The size of the wheels 10-15 is typically 15″, 19.5″ or 22.5″.

FIG. 1b is an enlarged view of details relating to wheel 10. Let us examine sensor means 30, 40 which comprise a sensor 40 and a sensor response element 30. The sensor 40 is preferably an inductive sensor which is immovably attached to an axle 90. The response element 30 of the sensor 40 is attached to the ring of a brake drum 20 or to other rotating part of the axle 90. Depending on the sensor type, the distance between the sensor 40 and the response element 30 varies, the difference being typically in millimetres. The sensor measures changes that take place in the magnetic field formed when the response element 30 moves. As the response element 30 passes the sensing head of the sensor 40, the sensor 40 generates a pulse. The operating voltage of the sensor 40 is typically 24 volts, which is the voltage typically provided by the towing vehicle 3, the pulse generated being also 24 volts. The sensor 40 may also be other than an inductive sensor, for example an optical, mechanical or magnetic switch.

Information about the rotating of wheel 10 is relayed from the sensor 40 to the control unit 60 over a signal conductor 50. According to the preferred embodiment of the invention, the information is relayed in pulse form, i.e. when wheel 10 is rotating the sensor 40 relays pulse data to the control unit 60. Since the operating voltage level of the control unit 60 may be different than that of the sensor 40, adjustment of voltage level from 24 to 5 volts, for example, may also be needed. The control unit 60 preferably monitors the number of pulses coming from all sensors 40-45 for a predetermined period called a control period. If no pulses are received from even one of the wheels 10-15 within the control period, the control unit 60 raises an alarm. On the other hand, if all the wheels 10-15 are substantially stationary, i.e. no pulse signals are received from any of the sensors 40-45, the control unit 60 is arranged to detect that the trailer 2 has stopped, and it does not raise an alarm. The control unit 60 preferably comprises a processor, memory and external logic. External logic includes an input stage for receiving a pulse signal from the sensors, an output stage for sending an alarm signal to an alarm unit 80, a voltage source, and possibly a voltage level adapter.

If at least one of the wheels 10, 11, 12, 13, 14 or 15 is detected to be locked up, the control unit 60 relays a command through a connector 70 for raising an alarm to the alarm unit 80 located in the driver's cabin. An alarm signal is preferably relayed and the alarm unit 80 raises an alarm informing the driver of the transport device 1 of the lockup. The connector 70 is preferably a prior art connector between the trailer and the towing vehicle, the connector having typically 15 terminals of which one pin may be taken in use. Therefore, additional connections between the trailer 2 and the towing vehicle 3 are usually not needed. The alarm unit 80 may be any kind of alarm-raising device, preferably a device producing a light and/or sound signal in response to the alarm signal relayed from the control unit 60. The alarm unit 80 may be integrated into other devices of the transport device 1, for example as one of the warning lights on the dashboard. The above described detector device 4 is activated preferably when the trailer 2 is connected to the towing vehicle 3 and power is switched on in the towing vehicle 3.

FIG. 2 illustrates the operation of the control unit 60 according to a preferred embodiment of the invention in greater detail with reference to a flow diagram. When the detector device 4 is activated, the control unit 60 is activated 200 by connecting the operating voltage to the control unit 60. The control unit 60 monitors the rotating of the wheels 10-15 by reading 201 the pulse data obtained from the sensors 40-45 into the memory for the duration of the predetermined control period. The control period may be measured by activating a timer to start timing preferably from the moment the control unit 60 starts to read the pulse data. When the timer shows that the control period has expired, the control unit 60 checks the memory to find out whether all pulse data have been updated 202. If the pulse data of even one of the sensors 40-45 have not been updated, an alarm is raised by sending an alarm signal 203 to the alarm unit 80. If pulse data 204 have been received from all the sensors 40-45, the control unit preferably deletes the stored pulse data and starts to read new pulse data 201 obtained from the sensors 40-45. As already stated, the control unit 60 does not raise an alarm if all the wheels 10-15 are stationary, i.e. pulse data have not been stored from any of the sensors 40-45. The control period is set so that a momentary lockup of one or more wheels 10-15, due to braking for example, does not cause an alarm to be raised. However, to ensure that the driver of the transport vehicle 1 receives the alarm rapidly enough, a suitable control period is from 2 to 15 seconds, preferably about 5 seconds. The above described functionality is preferably programmed into the memory of the control unit 60 for execution by a processor.

The detector device 4 of the preferred embodiment of the invention allows the driver of the transport device to be rapidly informed about the lockup of one or more wheels, caused for example by freezing, a loose tyre or a damaged bearing. This allows hazardous situations and breakdowns to be avoided particularly when the vehicle is starting to move. In a transport device carrying inflammable substances, for example, a wheel that has been locked up for too long may cause a major hazard if the tyre catches fire. Moreover, the detector device 4 is fairly simple and economical to implement to existing transport device.

The preferred embodiment of FIGS. 1a and 1b illustrates a brake drum, which is widely used in trailers today. However, the disc brake is becoming increasingly common, both techniques being used to build new trailers. FIG. 3 illustrates an arrangement according to a preferred embodiment of the invention, taking only the essential parts into account, in which the sensor 40 measures rotation information from an axle provided with a disc brake with an ABS (Anti-Blockierungs-System) ring. Axles provided with disc brakes are very often provided with an ABS ring 300 from which the rotation information may be measured. The sensor means thus comprise the sensor 40 and a ring 300, the response element 30 of the sensor 40 being not needed. The ABS ring 300 is provided with gaps which allow the sensor 40 to generate a pulse signal based on changes in the magnetic field when a wheel is rotating. For the sake of clarity, FIG. 3 illustrates three hole-like gaps 301, 302 and 303, although it is apparent to a person skilled in the art that the ABS ring may be implemented in various ways. If the axle 90 in FIG. 1 is provided with a disc brake, and there is no ABS ring 300, the response element 30 of the sensor 40 may be used. The response element 30 can then be attached to a part that rotates simultaneously with the wheel 10, preferably to the hub of the wheel 10.

If the transport device 1 comprises an ABS brake system, the invention may be applied by utilizing ABS sensors, which may be arranged to monitor the rotating of the wheels whenever the transport device 1 moves (and not only when the driver is braking). The ABS central unit may also be arranged to carry out the functions illustrated in FIG. 2.

According to a preferred embodiment of the invention, the detector device 4 may also operate so that the sensors 40-45 relay signals of a different type, depending on whether the wheels 10-15 are rotating or whether they are locked up, to the control unit on a continuous basis. If the transport device 1 comprises bogie units that can be lifted up, this may be taken into account for example by programming the control unit 60 not to relay an alarm signal if no pulse signal is received from any of the sensors in the bogie unit. In another preferred embodiment an alarm may also be raised to the driver if the speed of rotation of a wheel becomes substantially slower compared with the other wheels.

According to a preferred embodiment of the invention, the detector device 4 also comprises means for monitoring braking, the means allowing to prevent an alarm command from being relayed to the alarm unit 80 when the driver of the transport device 1 is braking. Information about braking may be supplied to the control unit 60 preferably from the conductor of the brake lights of the trailer 2. The control unit 60 does not relay the command for an alarm if the control unit 60 receives information about braking when the brake pedal is being applied, i.e. the signal supplied to the brake lights. Another alternative is to arrange a pedal sensor in an operational connection with the brake pedal, the pedal sensor relaying the information to the control unit 60 when the driver brakes. This allows any alarms for wheel lockup caused by braking to be entirely avoided and a shorter control delay to be applied.

It is apparent to a person skilled in the art that as technology advances, the basic idea of the invention can be implemented in various ways. The invention and its embodiments are therefore not restricted to the above described examples but they may vary within the scope of the claims.

1. A method for detecting the lockup of wheels caused by freezing or some other problem in a transport device comprising at least two wheels, the method comprising the steps of
detecting the rotating of at least one wheel using at least one set of sensor means;
relaying information about the rotating of the at least one wheel from the sensor means to a control unit;
monitoring the rotating of the at least one wheel in the control unit on the basis of said information for at least a predetermined control period;
relaying a command from the control unit to an alarm unit for raising an alarm in response to the control unit detecting on the basis of said information that the at least one wheel is locked up; and
raising an alarm in response to the command for raising an alarm.

2. A method according to claim 1, wherein the lockup of the at least one wheel is detected in response to the control unit not receiving said information from the sensor means during the predetermined control period.

3. A method according to claim 2, wherein the predetermined control period is about 5 seconds.

4. A method according to claim 1, wherein the alarm is raised using a sound signal and/or a light signal.

5. A method according to claim 1, wherein the command for raising an alarm is not relayed when the transport device is braking.

6. A method according to claim 1, wherein, in response to said information indicating that none of the monitored wheels is rotating, the transport device is interpreted to have been stopped and a command for raising an alarm is not relayed.

7. A method according to claim 1, wherein the rotating of the at least one wheel is detected using sensors of the ABS braking system.

8. A detector device for detecting the lockup of wheels caused by freezing or some other problem in a transport device comprising at least two wheels, said detector device comprising
sensor means for detecting the rotating of at least one wheel;
a control unit operationally connected to the sensor means, the sensor means being arranged to relay information to the control unit about the rotating of the at least one wheel, and the control unit being arranged to monitor the rotating of the at least one wheel on the basis of said information for the duration of a predetermined control period; and
an alarm unit operationally connected to the control unit, the control unit being arranged to relay to the alarm unit a command for raising an alarm in response to said information indicating that the at least one wheel is locked up, the alarm unit being arranged to raise an alarm in response to the command for raising an alarm.

9. A detector device according to claim 8, wherein the sensor means are arranged to relay pulse data to the control unit when the at least one wheel is rotating;
the control unit is arranged to relay an alarm signal to said alarm unit is response to pulse data relating to the at least one wheel being not received during the predetermined control period.

10. A detector device according to claim 9, wherein the sensor means comprise a response element arranged on the brake drum of the wheel or on the hub of a disc brake wheel and an inductive sensor attached to an axle of the transport device, the sensor generating pulse data as the response element passes the sensor.

11. A detector device according to claim 9, wherein the sensor means comprise at least one inductive sensor generating pulse data when the ABS ring of the transport device is rotating.

12. A detector device according to claim 8, wherein
said detector device comprises means operationally connected to the control unit and monitoring braking;
the means monitoring braking are arranged to relay the braking information to the control unit in response to the transport device braking; and
the control unit is arranged to prevent said command from being relayed to the alarm unit in response to the braking information received at the control unit.
